(19) United States
(12) Patent Application Publication
(10) Pub. No.: US 2016/0037760 A1
(43) Pub. Date: Feb. 11, 2016

(54) FISHING LURE CONTAINMENT DEVICE

(71) Applicant: Daniel A. Melvin, Arcadia, IN (US)

(72) Inventor: Daniel A. Melvin, Arcadia, IN (US)

(21) Appl. No.: 14/451,622

(22) Filed: Aug. 5, 2014

(51) Int. Cl. A01K 97/06; A01K 87/00

(52) U.S. Cl. CPC A01K 97/06; A01K 87/00

(57) ABSTRACT

A fishing system including a fishing rod, a fishing line, a fishing lure coupled to the fishing line, and a fishing lure containment system. The fishing lure containment system contains at least a part of the fishing lure. The fishing lure containment system is couplable to a feature of the fishing rod. The fishing lure containment system has a housing having a cavity configured to hold at least a part of the lure, and a coupling element extending from the housing. The coupling element is configured to engage the feature of the fishing rod.

### BACKGROUND OF THE INVENTION

1. Field of the Invention

The present invention relates to a fishing apparatus, and, more particularly, to a fishing lure transport device with a cavity therein.

2. Description of the Related Art

Humankind has pursued fishing for survival, for commercial purposes and for sport from time immemorial. Pursuit of sport fishing has produced a plethora of products in the way of boating innovations, fish finders, lures, fishing lines, reels, fishing rods and other tackle.

The basic equipment of fishing consists of a barbed metal hook at the end of a fishing line and a wood, fiberglass or metal pole that usually has some type of spool or reel, near the handle, by which the fishing line is retrieved. Recreational fishing is practiced throughout the world and is done in freshwater and saltwater. The most popular game fish are salmon, trout, bass and pike in freshwater and sailfish, tuna, marlin, tarpon and bonefish in saltwater. There are two basic types of freshwater tackle, those for fly-casting and those for bait-casting.

Live bait or a variety of plugs, spoons and other artificial lures can be cast and pulled in, popped along the surface, trolled from a moving boat or allowed to rest at a predefined position in the water assisted by a bobber floating on the surface of the water. Spinning tackle requires an angler to keep the lure moving by repeatedly casting the spinning tackle and reeling it back in. Bait fishing includes applying a bait to a hook and casting the bait, which may be additionally weighted, into a likely area where fish may be, and allowing the bait to be suspended in the water to tempt the fish. Often a fishing bobber is used to hold the bait at a suspended distance from the surface of the water. The fisherman then watches the bobber as an indicator of when a fish is nibbling or has taken the bait. Movement of the bobber alerts the fisherman to pull on the fishing line in an attempt to set the hook in the fish's mouth.

A common experience by those pursuing the sport of fishing is being hooked by the barbed point of the fishing hook itself either on the fisherman's clothing or person. While undertaking the actual fishing the hooks of the lure need to be exposed in order for the lure to be effective and to perform their expected function, when the fishing rod is being transported the hooks are often still exposed.

One solution is to always remove the lure or hook from the end of the fishing line, but often people simply use one segment of the hook to hook the lure to a line guide of the fishing rod and then tighten the line so that it stays in place. This of course leaves the hooks exposed and can lead to the hooks getting caught on things or potentially injure people or pets.

What is needed in the art of fishing is a device to eliminate exposed fishing barbs when the fishing rod is being transported.

### SUMMARY OF THE INVENTION

The present invention is directed to a container to hold fishing lures and to be connectable to an eyelet of a fishing rod.

The present invention consists in one form thereof as a fishing system including a fishing rod, a fishing line, a fishing lure coupled to the fishing line, and a fishing lure containment system. The fishing lure containment system contains at least a part of the fishing lure. The fishing lure containment system is couplable to a feature of the fishing rod. The fishing lure containment system has a housing having a cavity configured to hold at least a part of the lure, and a coupling element extending from the housing. The coupling element is configured to engage the feature of the fishing rod.

The present invention consist in another form thereof as a fishing lure containment system including a housing having a cavity configured to hold at least a part of the lure, and a coupling element extending from the housing. The coupling element is configured to engage the feature of the fishing rod.

An advantage of the present invention is that it allows a lure to be transported without the hooks on the lure snagging something or someone.

Another advantage of the present invention is that the lure is hidden from view while in the containment device, which can be an advantage during a fishing contest.

Yet another advantage of the present invention is that the containment/transport device can remain on the lure while casting of the fishing rod is practiced.

Yet another advantage of the present invention is that the transport device may also serve as a flotation device such as a bobber.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a fishing rod having an embodiment of a fishing lure containment device of the present invention;

FIG. 2 is a perspective view of the fishing lure containment device of FIG. 1;

FIG. 3 is a partially sectioned view of the fishing lure containment device of FIGS. 1 and 2, showing a representative lure therein; and

FIG. 4 is a view of the fishing lure containment device of FIGS. 1-3 opened to show some of the internal features thereof.

Corresponding reference characters indicate corresponding parts throughout the several views. The exemplifications set out herein illustrates one embodiment of the invention, in one form, and such exemplification is not to be construed as limiting the scope of the invention in any manner.

### DETAILED DESCRIPTION OF THE INVENTION

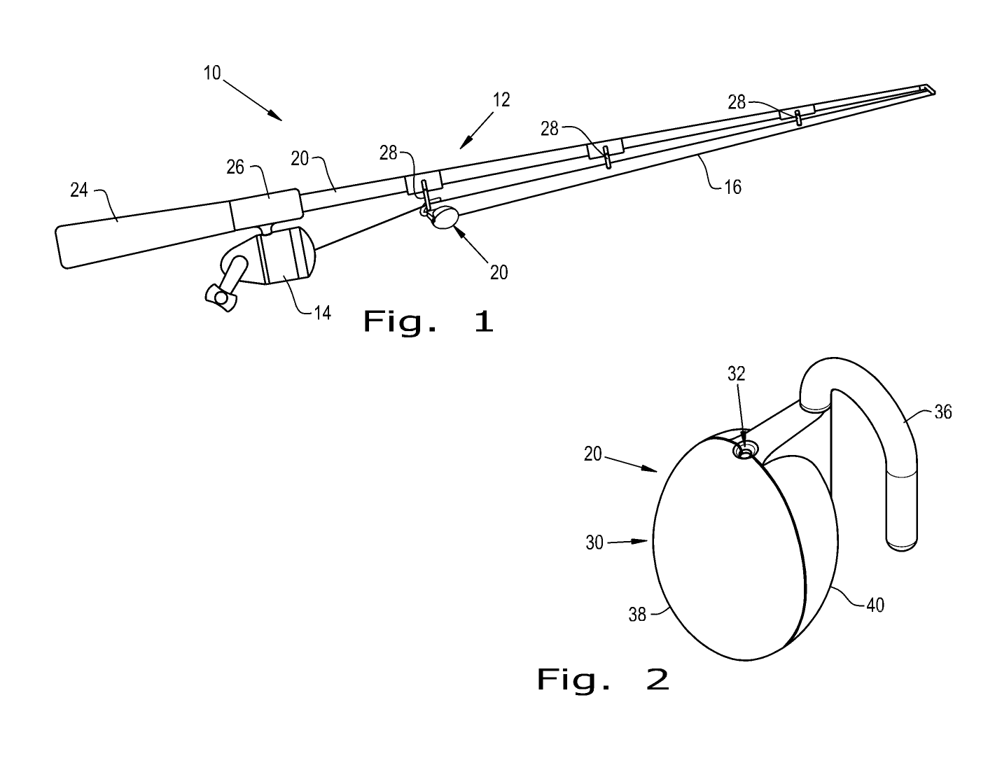

Referring now to the drawings, and more particularly to FIGS. 1-4, there is shown a fishing system 10 which generally includes a fishing rod 12, a reel 14, fishing line 16, a fishing lure 18 and an embodiment of a fishing line containment system 20 of the present invention.

Fishing rod 12 includes shaft 22, handle 24, reel mount 26 and line guides 28. Shaft 22 is a flexible shaft which assists in the casting of fishing line 16 and provides tension on fishing line 16 during the retrieval of fishing line 16. The flexibility of shaft 22 is selected based on the type of fish sought and the fisherman's preferences. Handle 24 is attached to one end of shaft 22. Located at a position next to handle 24 is reel mount 26. Along the length of shaft 22 are located line guides 28. Line guides 28 are spaced to accommodate fishing line 16.

Handle 24 is attached to an end of shaft 22 to provide an ergonomic grip to the user of fishing rod 12. Handle 24 is cushioned and made of a slip resistant material. Reel mount 26 is mounted adjacent to handle 24 in order to place reel 14 proximate handle 24 thereby facilitating the use of reel 14 by the user. Line guides 28 are located along shaft 22 having openings therethrough to provide for the guiding of fishing line 16 along the length of shaft 22. Line guides 28 are well known in the art and are affixed to shaft 22.

Reel 14 is a casting type of reel which is configured to contain fishing line 16 for release upon a coordinated casting action and actuation of reel 14 by the user. Reel 14 is used to retrieve fishing line 16 and to store fishing line 16 thereon.

Fishing line 16 is a filament, a woven line or a metal line. Fishing line 16 is stored on reel 14 and released by a user in a casting motion to cast a bait or lure 18 into water.

Fishing lure transport or containment device 20, has a housing 30 with holes 32 and 34 extending therethrough and a hook 36 extending therefrom. Housing 30 has a first portion 38 and a second mating portion 40. Portions 38 and 40 are pivotally connected by a hinge 42, and secured together by a biasing mechanism 44. It is also contemplated to have a latch mechanism on a side opposite hinge 42. A flotation portion 46 may be integrally formed to allow lure containment device 20 to also serve as a bobber. It is also contemplated that other portions of containment device 20 may be constructed to aid in flotation. Although housing 30 is shown as being hinged, other constructs are also contemplated, such as two parts being coupled together in some other manner such as being threaded together, or as one part having an opening and a slot for fishing line 16.

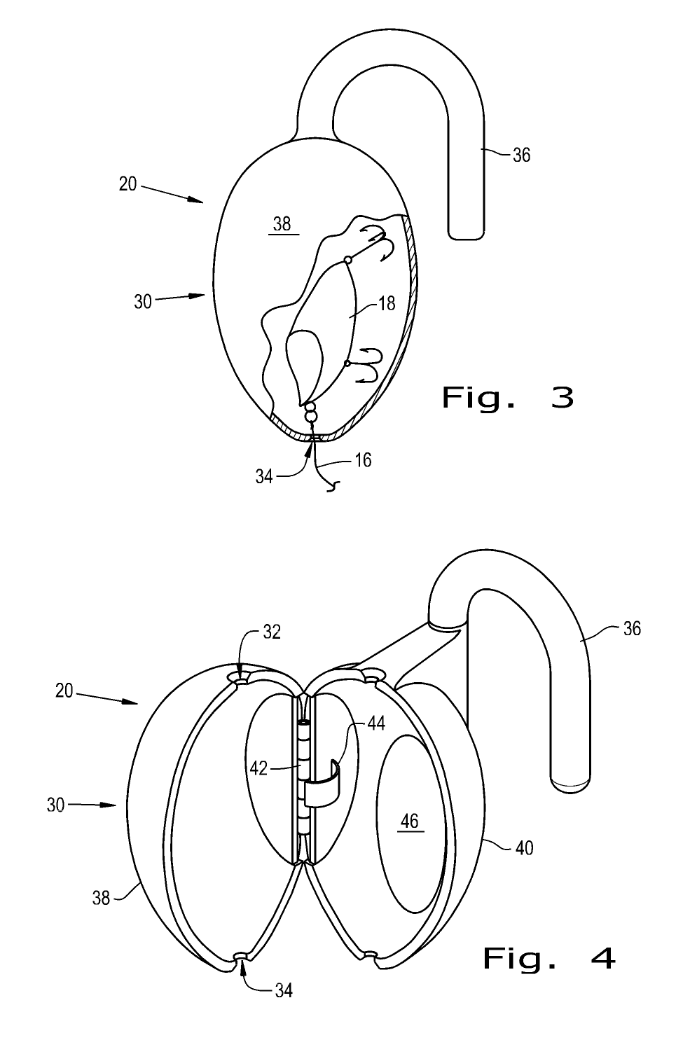

Hook 36 extends from housing 30 and is sized to fit a fishing line guide 28 on fishing rod 12 or onto a portion of reel 14. Hook 36 is a coupling element 36 that is hook-shaped or is generally U-shaped. A lure 18, as depicted in FIG. 3, is placed inside of housing 30 by opening housing 30, portions 38 and 40 which are pivoted together and biasing mechanism 44 secures lure 18 therein. Fishing line 16 attached to lure 18 extends from housing 30. Fishing line 16 is coupled to the fishing rod/reel and line 16 is tightened by using reel 14 so that hook 36 remains coupled to the fishing line guide 28 due to tension applied to fishing line 16 and a braking system on reel 14.

To remove transport device 20 fishing line tension is reduced by way of manipulating reel 14, or by simply bending rod 12, to unhook hook 36 from fishing line guide 28. Portions 38 and 40 are pivoted about hinge 42 to thereby release fishing lure 18.

It is contemplated that transport device 20 may be referred to as a “lure egg” based on the general shape of the illustrated embodiment. It is contemplated to make the lure egg by using a plastic molding technique. Perhaps forming it as two parts and assembling the hinge portions together to thereby form the ready to use lure egg. It is contemplated that the lure egg will be made in different sizes to accommodate the different sizes of lures. Hinge 42 may have a metal rod inserted into the respective plastic portions to form the hinge.

Advantageously the present invention allows lure 18 to be transported without the hooks on the lure snagging something or someone. Also, lure 18 is hidden from view, which can be an advantage during a fishing contest. Additionally, transport device 20 can remain on the lure and casting of the fishing rod can be practiced without removing lure 18. Still further it is also contemplated that transport device 20 may also serve as a flotation device such as a bobber.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fishing system, comprising:
a fishing rod;
a fishing line associated with said fishing rod;
a fishing lure coupled to said fishing line; and
a fishing lure containment system containing at least a part of said fishing lure, said fishing lure containment system being couplable to a feature of said fishing rod, said fishing lure containment system including:
a housing having a cavity configured to hold at least a part of said lure; and
a coupling element extending from said housing, said coupling element being configured to engage said feature of said fishing rod.

2. The fishing system of claim 1, wherein said housing is openable to one of receive said lure and release said lure.

3. The fishing system of claim 2, wherein said coupling element is generally U-shaped.

4. The fishing system of claim 2, wherein said housing has a first part and a second part, said first part being hinged to said second part.

5. The fishing system of claim 4, wherein said housing has a retaining element to retain said housing in a closed mode.

6. The fishing system of claim 5, wherein said retaining element is at least one of a biasing mechanism and a latching mechanism.

7. The fishing system of claim 5, wherein said housing has at least one opening in at least one of said first part and said second part to accommodate the passage of said fishing line.

8. The fishing system of claim 7, wherein said coupling element extends from one of said first part and said second part.

9. The fishing system of claim 8, wherein said housing has at least one flotation component.

10. The fishing system of claim 8, wherein said coupling element is hook-shaped and configured to enter an eyelet on said fishing rod.

11. A fishing lure containment system, comprising:
a housing having a cavity configured to hold at least a part of the lure; and
a coupling element extending from said housing, said coupling element being configured to engage a feature of a fishing rod.

12. The fishing lure containment system of claim 11, wherein said housing is openable to one of receive said lure and release said lure therefrom.

13. The fishing lure containment system of claim 12, wherein said coupling element is generally U-shaped.

14. The fishing lure containment system of claim 12, wherein said housing has a first part and a second part, said first part being hinged to said second part.

15. The fishing lure containment system of claim 14, wherein said housing has a retaining element to retain said housing in a closed mode.

16. The fishing lure containment system of claim 15, wherein said retaining element is at least one of a biasing mechanism and a latching mechanism.

17. The fishing lure containment system of claim 15, wherein said housing has at least one opening in at least one of said first part and said second part to accommodate the passage of a fishing line therethrough.

18. The fishing lure containment system of claim 17, wherein said coupling element extends from one of said first part and said second part.

19. The fishing lure containment system of claim 18, wherein said housing has at least one flotation component.

20. The fishing lure containment system of claim 18, wherein said coupling element is hook-shaped and configured to enter an eyelet on a fishing rod.
